(19) United States
(12) Patent Application Publication
(10) Pub. No.: US 2025/0088067 A1
(43) Pub. Date: Mar. 13, 2025

(54) COOLING DEVICE BASED ON GUIDANCE AND ISOLATION FOR ADSORPTION PERMANENT MAGNET GENERATORS OF GENERATOR SETS

(71) Applicant: Yangzhou Etepor Power Technology Co., Ltd., Yangzhou, Jiangsu (CN)

(72) Inventors: Jinbao CHEN, Yangzhou, Jiangsu (CN); Junjie DAI, Yangzhou, Jiangsu (CN)

(21) Appl. No.: 18/288,479

(22) PCT Filed: Jul. 15, 2022
(86) PCT No.: PCT/CN2022/105880

§ 371 Date: Oct. 26, 2023

(30) Foreign Application Priority Data
Jun. 21, 2022 (CN) 202210704255.0

(51) Int. Cl. H02K 5/20; F02B 63/04; H02K 7/18; H02K 9/06; H02K 21/14

(52) U.S. Cl. CPC H02K 5/207; F02B 63/042; H02K 7/1815; H02K 9/06; H02K 21/14

(57) ABSTRACT

The invention discloses a cooling device based on guidance and isolation for adsorption permanent magnet generators of generator sets, comprising a base, a generator cooling air duct body, an engine, a generator body, a reverse-suction heat conduction fan, a guiding isolation ring, an generator cooling air duct fixedly-connected annular plate, a volute air duct body for guiding and leading out the hot airflow and a soundproof shell, wherein the generator cooling air duct body is arranged on the base, an engine recoil starter is arranged at one end of the engine which is far away from the generator cooling air duct body, an air inlet is formed in the engine recoil starter, the guiding isolation ring is fixedly arranged on the generator cooling air duct body, and the generator cooling air duct fixedly-connected annular plate is fixedly arranged on the generator cooling air duct body. The invention relates to the technical field of permanent magnet generators, in particular to a cooling device based on guidance and isolation for adsorption permanent magnet generators of generator sets, which can efficiently dissipate heat of generator stator, rotor, etc. through negative pressure reverse suction, guide and discharge self-suction airflow through guiding isolation ring, effectively avoiding hot airflow rebound.

### 1. TECHNICAL FIELD

The invention relates to the technical field of permanent magnet generator, in particular to a cooling device based on guidance and isolation for adsorption permanent magnet generators of generator sets.

### 2. BACKGROUND ART

When the permanent magnet generator works, the temperature inside the generator is relatively high because of the impedance of its stator coil, when current passes through, heat is emitted. Most of the existing permanent magnet generators adopt external cooling fan to dissipate heat of the stator and rotor of the generator, the heat dissipation structure of which can lead to large overall size of the generator set and hot airflow cannot be effectively discharged, further influencing the heat dissipation efficiency of the permanent magnet generator.

The invention with publication number of CN101127468A discloses a cooling fan structure of permanent magnet generator, but its structure can not achieve guiding or discharging hot airflow and the hot airflow will rebound, limiting the heat dissipation effect.

### 3. SUMMARY OF THE INVENTION

Aims at the problems above and making up for the above existing defects, the invention provides a cooling device based on guidance and isolation for adsorption permanent magnet generators of generator sets, which can efficiently dissipate heat of generator stator, rotor, etc. through negative pressure reverse suction, guide and discharge self-suction airflow through guiding isolation ring, effectively avoiding hot airflow rebound.

The invention provides the following technical schemes: a cooling device based on guidance and isolation for adsorption permanent magnet generators of generator sets, comprising a base, a generator cooling air duct body, an engine, a generator body, a reverse-suction heat conduction fan, a guiding isolation ring, an generator cooling air duct fixedly-connected annular plate, a volute air duct body for guiding and leading out the hot airflow and a soundproof shell, wherein the generator cooling air duct body is arranged on the base and said engine is arranged on the base; one end of the generator cooling air duct body that is close to the engine is an unclosed structure; the output shaft of said engine extends to the inside of the generator cooling air duct body; an engine recoil starter is arranged at one end of the engine which is far away from the generator cooling air duct body, an air inlet is on the engine recoil starter; the guiding isolation ring is fixedly arranged on the generator cooling air duct body and is arranged at one end of the generator cooling air duct body that is far away from the engine; the generator cooling air duct fixedly-connected annular plate is fixedly arranged on the generator cooling air duct body. The generator body includes a generator rotor and a generator stator, both the generator rotor and generator stator are positioned inside the guiding isolation ring and said generator rotor is connected with the output shaft of the engine; a first guiding isolation air duct is formed between the engine and the generator cooling air duct body, a second guiding isolation air duct is formed among the generator rotor, generator stator, and the guiding isolation ring, said first guiding isolation air duct is combined with second guiding isolation air duct to form a guiding induced-draft channel, said reverse-suction heat conduction fan is arranged on said generator rotor and is positioned outside of the guiding isolation ring; said volute air duct body for guiding and leading out the hot airflow is fixedly arranged on said generator cooling air duct fixedly-connected annular plate; said guiding isolation ring is located inside the end that the volute air duct body for guiding and leading out the hot airflow and generator cooling air duct fixedly-connected annular plate connect, said reverse-suction heat conduction fan is located inside the volute air duct body for guiding and leading out the hot airflow, said soundproof shell is provided on the base and said one end of the volute air duct body for guiding and leading out the hot airflow extends into the soundproof shell.

In order to achieve the reverse suction flow of airflow and further achieve comprehensive heat dissipation of the generator body, said reverse-suction heat conduction fan includes a fixed circular plate, a fan blade ring and flow-guiding fan blades, said fixed circular plate is fixed on the generator rotor, said fan blade ring is provided on the outer circumference of the fixed circular plate, said flow-guiding fan blades are evenly distributed along the outer circumference of the fan blade ring, said flow-guiding fan blades are set in an arc shape which is raised to one side and the raised direction of said flow-guiding fan blades are opposite to the rotation direction of the generator body.

In order to achieve guided discharge of the hot airflow, said volute air duct body for guiding and leading out the hot airflow includes a baffle plate, a side baffle plate and an airflow discharge tube; said side baffle plate is provided at the inner circumference of the baffle plate, said airflow discharge outlet is provided at the corresponding position of the baffle plate and the side baffle plate, said airflow discharge tube is provided at the airflow discharge outlet, said airflow discharge tube extends into the soundproof shell, and said base is provided with a heat discharge slot.

Preferably, the center of the inner side of the baffle plate is provided with a circular projection, and the height of the middle of the circular projection is higher than the height of the side, so that the airflow can rotate and flow between the side baffle plate and the center projection to achieve guiding the hot airflow to the airflow discharge tube.

In order to cooperate with the reverse-suction heat conduction fan for guiding the hot airflow and avoiding the rebound of the hot airflow, the reverse-suction heat conduction fan is located at the center of the volute air duct body for guiding and leading out the hot airflow, and the gap between the inner wall of the volute air duct body for guiding and leading out the hot airflow and the reverse-suction heat conduction fan is 2˜3 cm.

Preferably, said base is provided with a plurality of air inlet slots, which are located below the engine.

The beneficial effects achieved by using the above structure of the invention is as follows: the proposed cooling device based on guidance and isolation for adsorption permanent magnet generators of generator sets, through the setting of the reverse-suction heat conduction fan, achieves the reverse-suction discharge of the heat generated during the work of the generator body, and the airflow is guided and isolated by the generator cooling air duct body and the guiding isolation ring, and at the same time, through the guiding effect of volute air duct body for guiding and leading out the hot airflow, the hot airflow from the guiding isolation ring is guided and isolated by the guiding isolation ring, and the hot airflow is rotated between the side baffle plate and the round projection of the volute air duct body for guiding and leading out the hot airflow, and finally guided to the airflow discharge outlet and the airflow discharge tube, so as to achieve efficient cooling of the generator body.

### 4. BRIEF DESCRIPTION OF ACCOMPANY DRAWINGS

Drawings are provided for further understanding of the invention and constitutes a part of the specification; the drawings and embodiments are used to explain the invention and not the limitation of in invention. In the drawings:

FIG. 1 is the overall location structural diagram of the cooling device based on guidance and isolation for adsorption permanent magnet generators of generator sets provided by the invention;

FIG. 2 is the is the overall structural diagram of the cooling device based on guidance and isolation for adsorption permanent magnet generators of generator sets provided by the invention;

FIG. 3 is the diagram illustrating the positional relationship among the generator cooling air duct body, the guiding isolation ring, and generator cooling air duct fixedly-connected annular plate of the cooling device based on guidance and isolation for adsorption permanent magnet generators of generator sets provided by the invention;

FIG. 4 is the diagram illustrating the positional relationship between the generator cooling air duct body and generator cooling air duct fixedly-connected annular plate of the cooling device based on guidance and isolation for adsorption permanent magnet generators of generator sets provided by the invention;

FIG. 5 is the structural diagram of reverse-suction heat conduction fan of the cooling device based on guidance and isolation for adsorption permanent magnet generators of generator sets provided by the invention;

FIG. 6 is the mounting structural diagram of reverse-suction heat conduction fan of the cooling device based on guidance and isolation for adsorption permanent magnet generators of generator sets provided by the invention;

FIG. 7 is the inner structural diagram of volute air duct body for guiding and leading out the hot airflow of the cooling device based on guidance and isolation for adsorption permanent magnet generators of generator sets provided by the invention;

FIG. 8 is the outer structural diagram of volute air duct body for guiding and leading out the hot airflow of the cooling device based on guidance and isolation for adsorption permanent magnet generators of generator sets provided by the invention;

As shown in the accompanying drawings: 1 base, 2 generator cooling air duct body, 3 generator body, 4 reverse-suction heat conduction fan, 5 guiding isolation ring, 6 generator cooling air duct fixedly-connected annular plate, 7 volute air duct body for guiding and leading out the hot airflow, 8 soundproof shell, 9 air inlet, 10 fixed circular plate, 11 fan blade ring, 12 flow-guiding fan blade, 13 baffle plate, 14 side baffle plate, 15 airflow discharge tube, 16 airflow discharge outlet, 17 heat discharge slot, 18 circular projection, 19 air inlet slots, 20 engine.

### 5. SPECIFIC EMBODIMENT OF THE INVENTION

The invention is further described in detail hereinafter with reference to the drawings. Obviously, embodiments described are only partial embodiments of the invention and the actual structure is not limited thereto. In general, it is to be understood by those skilled in the art that non-creative design of structural forms and embodiments that are similar to the technical solutions without departing from the spirit of the invention shall all fall within the protective scope of the invention.

It should be noted that the words “front”, “back”, “left”, “right”, “up” and “down” used in the following description refer to the orientation in the drawings, and the words “inside” and “outside” refer to directions toward or away from the geometric center of a particular part, respectively.

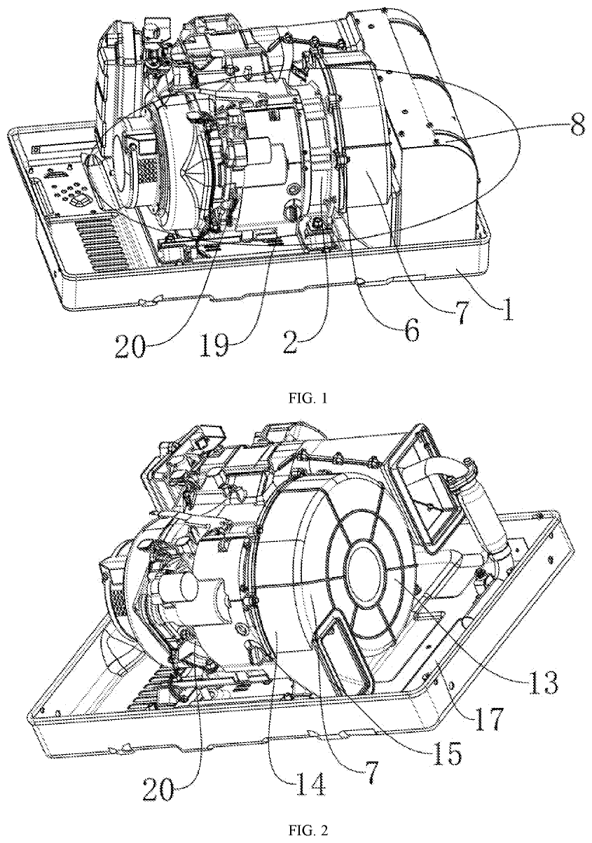

As shown in FIG. 1, the technical solution adopted in the invention is the part in the oval area in FIG. 1 (schematic diagram of the overall engine structure).

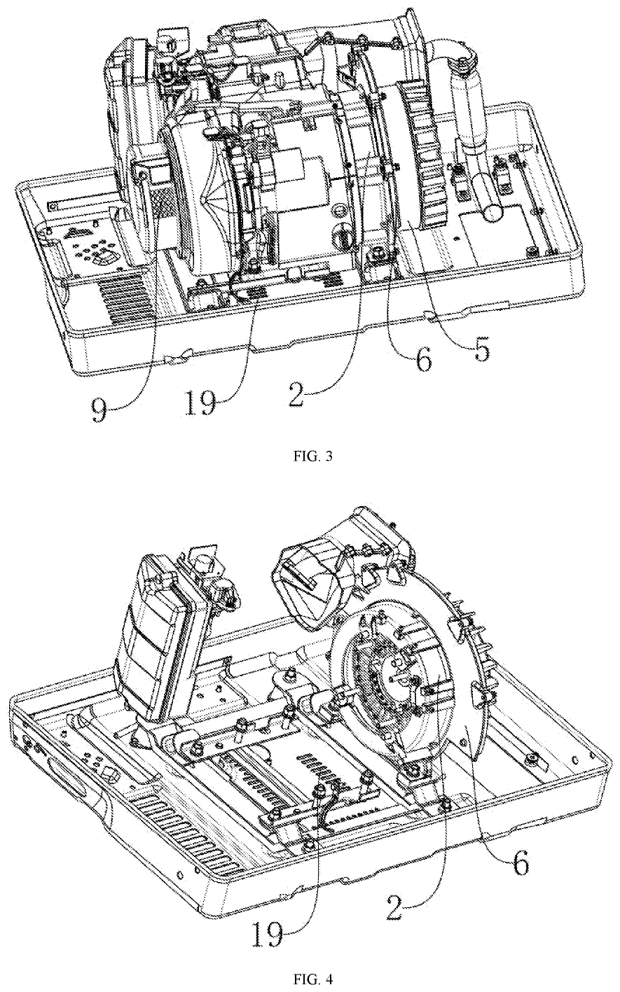

As shown in FIG. 1, FIG. 2, FIG. 3, and FIG. 4, the invention provides a cooling device based on guidance and isolation for adsorption permanent magnet generators of generator sets, comprising a base 1, a generator cooling air duct body 2, a generator body 3, a reverse-suction heat conduction fan 4, a guiding isolation ring 5, an generator cooling air duct fixedly-connected annular plate 6, a volute air duct body for guiding and leading out the hot airflow 7, a soundproof shell 7 and an engine 20, wherein the generator cooling air duct body 2 is arranged on the base 1 and said engine 20 is arranged on the base 1; one end of the generator cooling air duct body 2 that is close to the engine 20 is an unclosed structure; the output shaft of said engine 20 extends to the inside of the generator cooling air duct body 2; an engine recoil starter is arranged at one end of the engine 20 which is far away from the generator cooling air duct body 2, an air inlet 9 is on the engine recoil starter; the guiding isolation ring 5 is fixedly arranged on the generator cooling air duct body 2 and is arranged at one end of the generator cooling air duct body 2 that is far away from the engine 20; the generator cooling air duct fixedly-connected annular plate 6 is fixedly arranged on the generator cooling air duct body 2. Said generator body 3 includes a generator rotor and a generator stator, both the generator rotor and generator stator are positioned inside the guiding isolation ring 5 and said generator rotor is connected with the output shaft of the engine 20; a first guiding isolation air duct is formed between the engine and the generator cooling air duct body 2, a second guiding isolation air duct is formed among the generator rotor, generator stator, and the guiding isolation ring 5, said first guiding isolation air duct is combined with second guiding isolation air duct to form a guiding induced-draft channel, said reverse-suction heat conduction fan 4 is arranged on said generator rotor and is positioned outside of the guiding isolation ring 5; said volute air duct body for guiding and leading out the hot airflow 7 is fixedly arranged on said generator cooling air duct fixedly-connected annular plate 6; said guiding isolation ring 5 is located inside the end that the volute air duct body for guiding and leading out the hot airflow 7 and generator cooling air duct fixedly-connected annular plate 6 connect, said reverse-suction heat conduction fan 4 is located inside the volute air duct body for guiding and leading out the hot airflow 7, the coordination among the first guiding isolation air duct, the second guiding isolation air duct, and the volute air duct body for guiding and leading out the hot airflow form a communicated airflow channel wherein the low-temperature airflow is brought from the air inlet 9 on the engine recoil starter via the action of reverse-suction heat conduction fan 4, and flows along the airflow channel among the first guiding isolation air duct, the second guiding isolation air duct, and the volute air duct body for guiding and leading out the hot airflow, thereby cooling the generator rotor and generator stator; the soundproof shell 8 is provided on the base 1 and one end of the volute air duct body for guiding and leading out the hot airflow 7 extends into the soundproof shell 8.

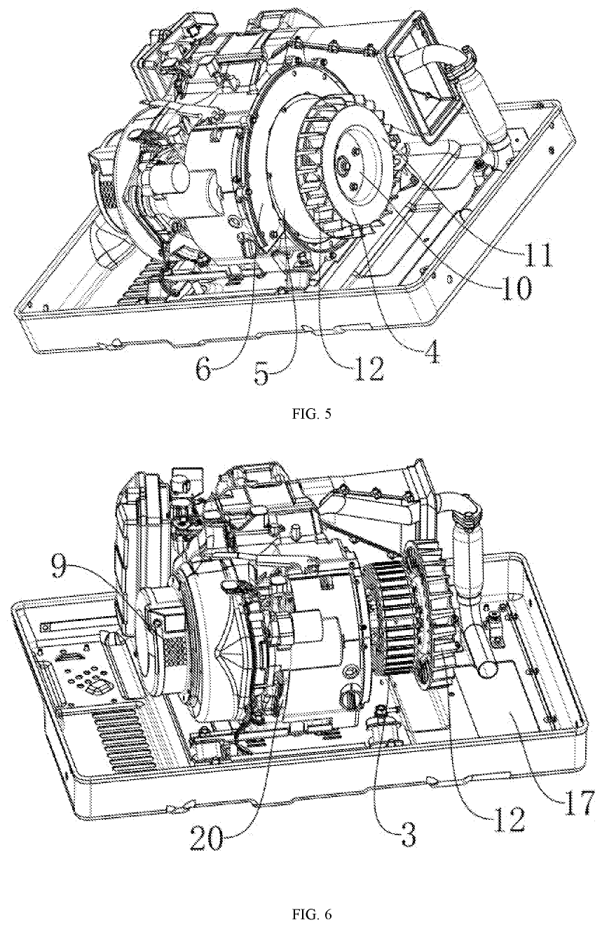

As shown in FIG. 5 and FIG. 6, said reverse-suction heat conduction fan 4 includes a fixed circular plate 10, a fan blade ring 11 and flow-guiding fan blades 12, said fixed circular plate 10 is fixed on the generator rotor, said fan blade ring 11 is provided on the outer circumference of the fixed circular plate 10, said flow-guiding fan blades 12 are evenly distributed along the outer circumference of the fan blade ring, said flow-guiding fan blades 12 are set in arc shape which is raised to one side and the raised direction of said flow-guiding fan blades 12 is opposite to the rotation direction of the generator body 3.

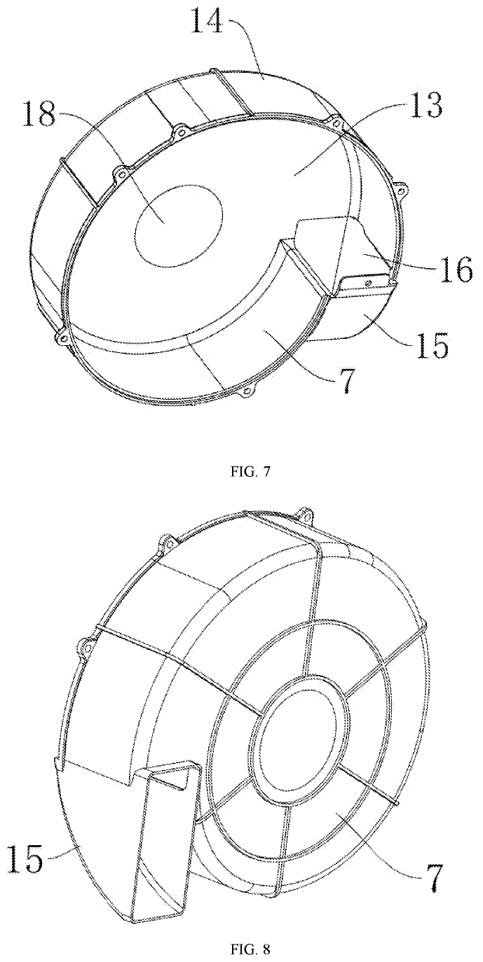

As shown in FIG. 7 and FIG. 8, said volute air duct body for guiding and leading out the hot airflow 7 includes a baffle plate 13, a side baffle plate 14 and an airflow discharge tube 15; said side baffle plate 14 is provided at the inner circumference of the baffle plate 13, said airflow discharge outlet 16 is provided at the corresponding position of the baffle plate 13 and the side baffle plate 14, said airflow discharge tube 15 is provided at the airflow discharge outlet 16, said airflow discharge tube 15 extends into the soundproof shell 8, and said base 1 is provided with a heat discharge slot 17. The center of the inner side of the baffle plate 13 is provided with a circular projection 18, and the height of the middle of the circular projection 18 is higher than the height of the side, so that the airflow can rotate and flow between the side baffle plate 14 and the center projection to guide the hot airflow to the airflow discharge tube 15. The reverse-suction heat conduction fan 4 is located at the center of the volute air duct body for guiding and leading out the hot airflow 7, and the gap between the inner wall of the volute air duct body for guiding and leading out the hot airflow 7 and the reverse-suction heat conduction fan 4 is 2˜3 cm.

As shown in FIG. 2, FIG. 3, and FIG. 4, said base 1 is provided with a plurality of air inlet slots 19, which are located below the engine 20 wherein the low-temperature airflow of air inlet slots 19 enters into the generator cooling air duct body 2 via the action of reverse-suction heat conduction fan 4, and achieve efficient cooling of the generator body 3 with the coordination of the supply air rate of the air inlet 9 on the engine recoil starter.

When in specific implementation, the generator cooling air duct body 2, the guiding isolation ring 5 and the volute air duct body for guiding and leading out the hot airflow 7 are matched to form a communicated airflow guiding channel, the rotation of the generator rotor drives the reverse-suction heat conduction fan 4 to rotate, low-temperature airflow is brought into the communicated airflow guiding channel from the air inlet 9 on the engine recoil starter through the arc-shaped flow-guiding fan blades 12, the low-temperature airflow moves along the airflow guiding channel to cool the generator rotor and the generator stator; the airflow after cooling the generator rotor and the generator stator is heated and enters the volute air duct body for guiding and leading out the hot airflow 7 and the hot airflow rotates in the inner cavity between the circular projection 18 and the side baffle plate 14 and is finally discharged through the airflow discharge outlet 16 and airflow discharge tube 15, and simultaneously, under the action of the reverse-suction heat conduction fan 4, the low-temperature cooling airflow enters the generator cooling air duct body 2 through the air inlet slots 19 arranged on the base 1, and is matched with the generator cooling air duct body 2 to cool the engine, the generator rotor and the generator stator synchronously; in the whole process, the isolation and guidance of hot airflow are achieved through the arrangement of the generator cooling air duct body 2, the guiding isolation ring 5 and the volute air duct body for guiding and leading out the hot airflow 7. And the external cold airflow is reversely sucked through the reverse-suction heat conduction fan 4 and the heated hot airflow is guided and discharged, achieving efficient cooling of the permanent magnet generator set.

It is noted that, herein, relational terms such as first and second, and the like may be used solely to distinguish one entity or action from another entity or action without necessarily requiring or implying any actual such relationship or order between such entities or actions. Furthermore, the terms “comprise”, “include” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Although embodiments of the invention have been shown and described, it will be understood by those skilled in the art that a variety of variations, modifications, replacements and variants of these embodiments may be made without departing from the principles and spirit of the invention. Therefore, the protection scope of the invention should be subject to the protection scope defined by the claims and equivalents thereof.

1. A cooling device based on guidance and isolation for adsorption permanent magnet generators of generator sets, comprising a base, a generator cooling air duct body, an engine, a generator body, a reverse-suction heat conduction fan, a guiding isolation ring, a generator cooling air duct fixedly-connected annular plate, a volute air duct body for guiding and leading out the hot airflow and a soundproof shell, wherein the generator cooling air duct body is arranged on the base and said engine is arranged on the base; one end of the generator cooling air duct body that is close to the engine is an unclosed structure; the output shaft of said engine extends to the inside of the generator cooling air duct body; an engine recoil starter is arranged at one end of the engine which is far away from the generator cooling air duct body, an air inlet is on the engine recoil starter; the guiding isolation ring is fixedly arranged on the generator cooling air duct body and is arranged at one end of the generator cooling air duct body that is far away from the engine; the generator cooling air duct fixedly-connected annular plate is fixedly arranged on the generator cooling air duct body; said generator body includes a generator rotor and a generator stator, both the generator rotor and generator stator are positioned inside the guiding isolation ring and said generator rotor is connected with the output shaft of the engine; said reverse-suction heat conduction fan is arranged on said generator rotor and is positioned outside of the guiding isolation ring; said volute air duct body for guiding and leading out the hot airflow is fixedly arranged on said generator cooling air duct fixedly-connected annular plate; said guiding isolation ring is located inside the end that the volute air duct body for guiding and leading out the hot airflow and generator cooling air duct fixedly-connected annular plate connect, said reverse-suction heat conduction fan is located inside the volute air duct body for guiding and leading out the hot airflow, said soundproof shell is provided on the base and said one end of the volute air duct body for guiding and leading out the hot airflow extends into the soundproof shell.

2. The cooling device for adsorption permanent magnet generators of generator sets of claim 1, wherein the reverse-suction heat conduction fan includes a fixed circular plate, a fan blade ring and flow-guiding fan blades, said fixed circular plate is fixed on the generator rotor, said fan blade ring is provided on the outer circumference of the fixed circular plate, said flow-guiding fan blades are evenly distributed along the outer circumference of the fan blade ring, said flow-guiding fan blades are set in an arc shape which is raised to one side and the raised direction of said flow-guiding fan blades are opposite to the rotation direction of the generator body.

3. The cooling device for adsorption permanent magnet generators of generator sets of claim 2, wherein the volute air duct body for guiding and leading out the hot airflow includes a baffle plate, a side baffle plate and an airflow discharge tube; said side baffle plate is provided at the inner circumference of the baffle plate, said airflow discharge outlet is provided at the corresponding position of the baffle plate and the side baffle plate, said airflow discharge tube is provided at the airflow discharge outlet, said airflow discharge tube extends into the soundproof shell, and said base is provided with a heat discharge slot.

4. The cooling device for adsorption permanent magnet generators of generator sets of claim 3, wherein the center of the inner side of the baffle plate is provided with a circular projection, and the height of the middle of the circular projection is higher than the height of the side.

5. The cooling device for adsorption permanent magnet generators of generator sets of claim 4, wherein the reverse-suction heat conduction fan is located at the center of the volute air duct body for guiding and leading out the hot airflow, and the gap between the inner wall of the volute air duct body for guiding and leading out the hot airflow and the reverse-suction heat conduction fan is 2˜3 cm.

6. The cooling device for adsorption permanent magnet generators of generator sets of claim 5, wherein the base is provided with a plurality of air inlet slots, which are located below the engine.
